(19) United States
(12) Patent Application Publication
(10) Pub. No.: US 2015/0127595 A1
(43) Pub. Date: May 7, 2015

(54) MODELING AND DETECTION OF ANOMALY BASED ON PREDICTION

(71) Applicant: Numenta, Inc., Redwood City, CA (US)

(72) Inventors: Jeffrey C. Hawkins, II, Atherton, CA (US); Subutai Ahmad, Palo Alto, CA (US)

(21) Appl. No.: 14/494,324

(22) Filed: Sep. 23, 2014

Related U.S. Application Data
(60) Provisional application No. 61/899,043, filed on Nov. 1, 2013.

(51) Int. Cl. G06N 7/00

(52) U.S. Cl. CPC G06N 7/005
USPC 706/46

(57) ABSTRACT

Embodiments relate to determining likelihood of presence of anomaly in a target system based on the accuracy of the predictions. A predictive model makes predictions based at least on the input data from the target system that change over time. The accuracy of the predictions over time is determined by comparing actual values against predictions for these actual values. The accuracy of the predictions is analyzed to generate an anomaly model indicating anticipated changes in the accuracy of predictions made by the predictive model. When the accuracy of subsequent predictions does not match the range or distribution as anticipated by the anomaly model, a determination can be made that the target system is likely in an anomalous state.

### CROSS-REFERENCE TO RELATED APPLICATIONS

The application claims priority under 35 U.S.C. §119(e) to U.S. Provisional Application No. 61/899,043 filed on Nov. 1, 2013, which is incorporated by reference herein in its entirety.

### BACKGROUND

1. Field of the Disclosure

The disclosure relates to modeling and presenting information regarding whether a target system is in an anomalous state based on the accuracy of predictions made by a predictive model.

2. Description of the Related Arts

Predictive analytics refers to a variety of techniques for modeling and data mining current and past data sets to make predictions. Predictive analytics allows for the generation of predictive models by identifying patterns in the data sets. Generally, the predictive models establish relationships or correlations between various data fields in the data sets. Using the predictive models, a user can predict the outcome or characteristics of a transaction or event based on available data. For example, predictive models for credit scoring in financial services factor in a customer's credit history and data to predict the likeliness that the customer will default on a loan.

Commercially available products for predictive analytics include products from IBM SSPS, KXEN, FICO, TIBCO, Portrait, Angoss, and Predixion Software, just to name a few. These software products use one or more statistical techniques such as regression models, discrete choice models, time series models and other machine learning techniques to generate useful predictive models. These software products generate different predictive models having different accuracies and characteristics depending on, among others, the amount of training data and available resources.

With a perfect predictive model, all patterns and sequences should be predicted. Such predictive model will always make an accurate prediction; and hence, no anomaly in prediction will ever arise. In practice, however, predictive models are imperfect and the data is not always predictable. Hence, the prediction made using a predictive model will often deviate from the actual value being predicted. Some of such deviation may be indicative of critical events or errors that may pose a significant risk or advantage to a user of the predictive model.

### SUMMARY

Embodiments relate to detecting an anomaly in a target system by making a prediction based on input data received from the target system and determining accuracy of the prediction. The prediction is generated by executing one or more predictive algorithms using the received input data. A current accuracy score representing accuracy of the prediction is generated. An anomaly score representing likelihood that the target system is in an anomalous state is generated based on the current accuracy score by referencing an anomaly model. The anomaly model represents anticipated range or distribution of accuracy of predictions made by the predictive model.

In one embodiment, the prediction is compared with an actual value corresponding to the prediction to generate the current accuracy score.

In one embodiment, the anomaly model is generated by analyzing a plurality of prior accuracy scores generated prior to generating the current accuracy score. The prior accuracy scores are generated by executing the predictive algorithm based on training data or prior input data provided to the predictive algorithm and comparing the plurality of predictions against a plurality of corresponding actual values.

In one embodiment, the accuracy score takes one of a plurality of discrete values. The likelihood is determined by computing a difference in cumulative distribution function (CDF) values at an upper end and a lower end of one of the plurality of discrete values.

In one embodiment, the likelihood is determined by computing a running average of the current accuracy score and prior accuracy scores preceding the current accuracy score, and determining the anomaly score by identifying an output value of the anomaly model corresponding to the running average.

In one embodiment, a number of the prior accuracy scores for computing the running average is dynamically changed based on predictability of the input data.

In one embodiment, the accuracy score is aggregated with one or more prior accuracy scores generated using the input data at time steps prior to a current time step for computing the current accuracy score.

In one embodiment, user input indicating a time period represented by the aggregated accuracy score is received.

In one embodiment, a time period represented by the aggregated accuracy score is increased or decreased when another user input is received.

In one embodiment, the predictive algorithm generates the prediction using a hierarchical temporal memory (HTM) algorithm or cortical learning algorithm.

In one embodiment, a plurality of predictions and a corresponding plurality of current accuracy scores are generated based on the same input data and associated with different parameters of the target system. The likelihood that the target system is in the anomalous state is determined based on a combined accuracy score that combines the plurality of current accuracy scores.

In one embodiment, the likelihood that the target system is in the anomalous state is determined based on change of correlation of at least two of the plurality of current accuracy scores.

### BRIEF DESCRIPTION OF THE DRAWINGS

The teachings of the embodiments of the present disclosure can be readily understood by considering the following detailed description in conjunction with the accompanying drawings.

Figure (FIG.) 1 is a conceptual diagram illustrating relationships between a target system, a predictive model and an anomaly model, according to one embodiment.

FIG. 2 is a block diagram illustrating an anomaly detector, according to one embodiment.

FIG. 3 is a flowchart illustrating a process of determining an anomalous state in a target system, according to one embodiment.

FIG. 4 is an example graphical user interface illustrating anomaly parameters aggregated in units of an hour, according to one embodiment.

FIG. 5 is an example graphical user interface illustrating anomaly parameters aggregated in units of 5 minutes, according to one embodiment.

FIG. 6 is a flowchart illustrating a process of aggregating anomaly parameters for presentation, according to one embodiment.

FIG. 7 is a conceptual diagram illustrating generating of combined anomaly parameters, according to one embodiment.

### DETAILED DESCRIPTION OF EMBODIMENTS

In the following description of embodiments, numerous specific details are set forth in order to provide more thorough understanding. However, note that the embodiments may be practiced without one or more of these specific details. In other instances, well-known features have not been described in detail to avoid unnecessarily complicating the description.

A preferred embodiment is now described with reference to the figures where like reference numbers indicate identical or functionally similar elements. Also in the figures, the left most digits of each reference number corresponds to the figure in which the reference number is first used.

Embodiments relate to determining likelihood of anomaly in a target system based on the accuracy of the predictions. A predictive model makes predictions based at least on temporally varying input data from the target system. The accuracy of the predictions over time is determined by comparing actual values against predictions for these actual values. The accuracy of the predictions is analyzed to generate an anomaly model which indicates the historical distribution in the accuracy of predictions made by the predictive model. When the accuracy of subsequent predictions deviates from the distribution as anticipated by the anomaly model, the target system is likely in an anomalous state.

The predictive model described herein refers to software, hardware, firmware or a combination thereof for processing input data from a target system to predict future values associated with the target system. The predictive model may include, for example, a threshold model, a Gaussian model, a regression model, a hierarchical temporal memory (HTM) algorithm or a cortical learning algorithm (available from Numenta, Inc. of Menlo Park, Calif.) and other machine learning algorithms.

The anomaly model described herein refers to a mathematical or conceptual model representing an anticipated range, or distribution of accuracy of predictions made by a predictive system. The anomaly model may be generated by processing prior predictions and corresponding accuracy values or modeling the predictive system and/or the target system. In some embodiments, the anomaly model is embodied in the form of a distribution function.

The anomalous state described herein refers to a state that deviates from an ordinary operating state of a target system. The anomalous state may be the result of change in the target system itself or the environment of the target system.

The target system described herein refers to a system that is the subject of observation by the predictive system for making predictions. The target system generates input data that can be fed to the predictive system. The target system may include, but not limited to, a computer network system, a mechanical system, a financial transaction system, a health maintenance system, and a transport system (e.g., airline reservation system).

### Modeling of Anomalous State in Target System

Figure (FIG.) 1 is a conceptual diagram illustrating relationships between a target system 102, a predictive model 110 and an anomaly model 120, according to one embodiment. The predictive model 110 does not always produce accurate predictions based on input data 104 from the target system 102. Due to the imperfection of the predictive model 110, inherent characteristics of the target system 102 (e.g., unobservable variables), the predictions may sometimes be accurate while at other times they may be inaccurate. The predictive model 110 compares its prediction against an actual value 108 to determine the accuracy of the prediction and generates the accuracy score 114 representing the accuracy or inaccuracy of its prediction.

The input data 104 may represent, among other information, resource usage data for computers, images, videos, audio signals, sensor signals, data related to network traffic, financial transaction data, communication signals (e.g., emails, text messages and instant messages), documents, insurance records, biometric information, parameters for manufacturing process (e.g., semiconductor fabrication parameters), inventory patterns, energy or power usage patterns, data representing genes, results of scientific experiments, parameters associated with operation of a machine (e.g., vehicle operation) and medical treatment data.

The prediction generated by the prediction model may be indicative of, but not limited to, whether data packets traversing a network will cause network issues (e.g., congestion), weather forecast, a person's behavior, gene expression and protein interactions, the amount of inventory, energy usage in a building or facility, web analytics (e.g., predicting which link or advertisement that users are likely to click), results of pending experiments, illness that a person is likely to experience, whether a user is likely to find contents interesting, result of election, whether a loan will be paid back, occurrence of adverse events, and reaction to medical treatments. The generated prediction may be (i) binary (e.g., 0 or 1), (ii) take one value from a range of values or (iii) indicate a range of values among many possible ranges of values.

An actual value 108 herein refers to information that can be used to determine whether a prediction made by the predictive model 110 was accurate. Although FIG. 1 illustrates the actual value 108 as being provided separately to the predictive model 110, in some embodiments, the actual value 108 may also be included in the input data 104 (e.g., an input data with a later time stamp may be the actual value 108 of a prediction associated with an input data with an earlier time stamp).

When the target system 102 is in a non-anomalous state, characteristics (e.g., average, trend or distribution) of the accuracy score 114 over a period of time can anticipate a certain behavior, even though it would be difficult to predict which individual predictions would be accurate or inaccurate. For example, if an average of accuracy scores is 0.5, half of the predictions will be accurate and the other half will be inaccurate. Such anticipated behavior of the accuracy score 114 may be formulated into the anomaly model 120. Models that can be used as the anomaly model 120 include a distribution model. The distribution model can be formatted in terms of probability distribution or other forms of data (e.g., histogram) suitable for deriving the probability distribution. In one or more embodiments, the anomaly model 120 receives the accuracy score 114, identifies a value corresponding to a certain accuracy score or a ranges of accuracy scores, and outputs the identified value as the anomaly parameter 124.

After the anomaly model 120 is generated, the anomaly model 120 may be referenced to determine whether the target system 102 is in an anomalous state. That is, if the accuracy scores 114 over a time period remain within a range or distribution as anticipated by the anomaly model 120, the target system is likely to be in a non-anomalous state. Conversely, if the accuracy score 114 over a time period does deviates from the range or distribution as anticipated by the anomaly model 120, the target system 102 is likely to be in an anomalous state. The likelihood that the target system 102 is in an anomalous state or a non-anomalous state can be represented by the anomaly parameter 124. The anomaly model 120 generates the anomaly parameter 124 based on the accuracy scores 114 over a number of predictions or time that is statistically meaningful.

### Example Architecture of Anomaly Detector

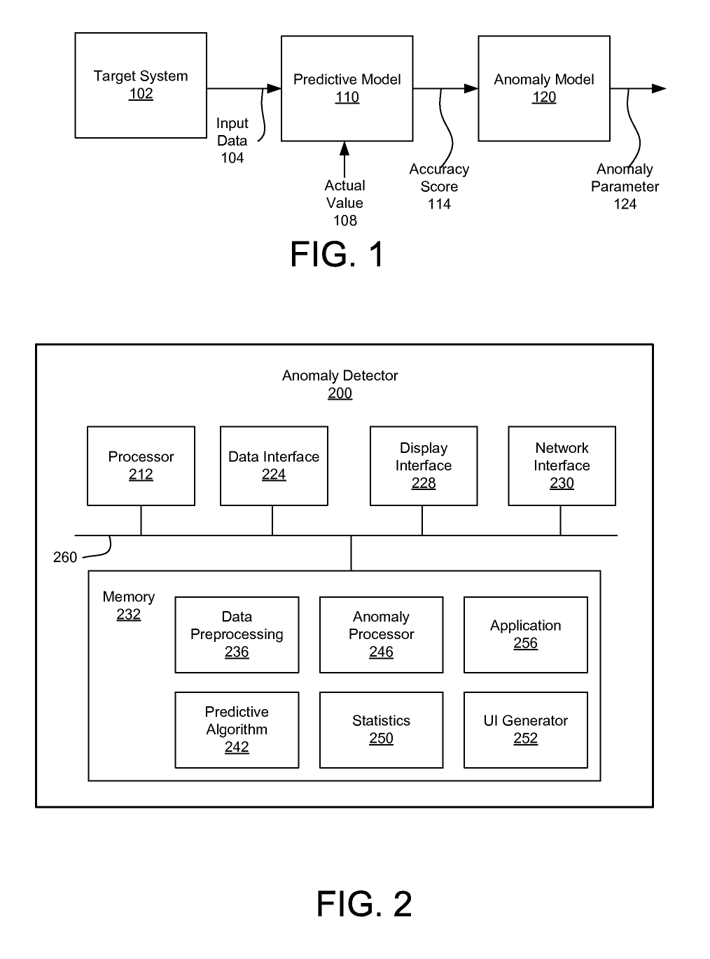

FIG. 2 is a block diagram illustrating an anomaly detector 200, according to one embodiment. The anomaly detector 200 receives the input data 104 from another device or computer and generates graphical user interface elements based on the anomaly parameter 124. In one embodiment, the anomaly detector 200 is embodied as a server that is connected to other devices functioning as the target system 102. Alternatively, the anomaly detector 200 may be part of the same computing system that also forms the target system 102.

The anomaly detector 200 may include, among other components, a processor 212, a data interface 224, a data interface 224, a display interface 228, a network interface 230, a memory 232 and a bus 260 connecting these components. One or more software components in the memory 232 may also be embodied as a separate hardware or firmware component in the anomaly detector 200. The anomaly detector 200 may include components not illustrated in FIG. 2 (e.g., an input device and a power source).

The processor 212 reads and executes instructions from the memory 232. The processor 212 may be a central processing unit (CPU) and may manage the operation of various components in the anomaly detector 200.

The data interface 224 is hardware, software, firmware or a combination thereof for receiving the input data 104. The data interface 224 may be embodied as a networking component to receive the input data over a network from another computing device. Alternatively, the data interface 224 may be a sensor interface that is connected to one or more sensors that generate the input data 104. In some embodiment, the data interface 224 may convert analog signals from sensors into digital signals.

The display interface 228 is hardware, software, firmware or a combination thereof for generating display data to be displayed on a display device. The display interface 228 may be embodied as a video graphics card. In one embodiment, the display interface 228 enables a user of the anomaly detector to views graphical user interface screens associated with the anomaly detection.

The network interface 230 is hardware, software, firmware or a combination thereof for sending data associated with anomaly detection to another device. The network interface 230 may enable the anomaly detector 200 to service multiple devices with anomaly data.

The memory 232 is a non-transitory computer readable storage medium that stores software components including among others, data preprocessing module 236, predictive algorithm module 242, anomaly processor 246, statistics module 250, user interface (UI) generator 252, and application 256. The memory 232 may store other software components not illustrate in FIG. 2, such as an operating system. The memory 232 may be implemented using various technologies including random-access memory (RAM), read-only memory (ROM), hard disk, flash memory and a combination thereof.

The data preprocessing module 236 receives the input data 104 via the data interface 224 and processes the input data 104 for feeding into the predictive algorithm module 242. The preprocessing may include, among others, converting data formats, filtering data, aggregating data, and adding or removing certain data. With respect to converting the data format, certain predictive algorithms can perform input data only in certain formats, and hence, the data preprocessing module 236 converts data in one format to another format compatible with the predictive algorithm module 242. For example, an HTM algorithm or a cortical learning algorithm (available from Numenta, Inc. of Menlo Park, Calif.) uses data to be in sparse distributed representation. Hence, the data preprocessing module 236 converts data in other formats to data in sparse distributed representation. Further, some input data needs to be aggregated before being fed into the predictive algorithm module 242 for enhanced prediction at the predictive algorithm module 242. The data preprocessing module 242 may perform such aggregation of the input data.

The predictive algorithm module 242 receives preprocessed input data from the data preprocessing module 236 to generate predictions and their corresponding accuracy scores. Various types of predictive algorithms may be deployed in the predictive algorithm module 242. The accuracy scores 114 indicate how accurate the predictions made by the predictive algorithm module 242 are relative to the actual values 108 corresponding to the predictions. The accuracy scores 114 may simply indicate that the prediction was correct (e.g., value of 1) or incorrect (e.g., value of 0). Alternatively, the accuracy scores 114 may take a value within a range (e.g., values between 0 and 1) or take one of a number of discrete values (e.g., 0, 0.25, 0.5, 0.75 and 1).

The anomaly processor 246 may (i) generate an anomaly model 120, and (ii) use the anomaly model 120 to process the anomaly parameter 124 based on the anomaly model 120. To generate the anomaly model 120, the anomaly processor 246 may process a number of accuracy scores (e.g., 1,000 accuracy scores) that were generated while the target system 102 was in a non-anomalous state or process a number of recent accuracy scores. By using the accuracy scores associated with the recent history, the anomaly processor 246 can generate an anomaly model that anticipates the behavior of accuracy scores. Specifically, the anomaly processor 246 uses the accuracy scores associated with the non-anomalous state or recent history to generate a distribution model that functions as the accuracy model 120. For this purpose, the anomaly processor 246 may generate a histogram of the accuracy scores associated with the non-anomalous state or recent anomaly scores, and then from the histogram, derive a normal distribution curve for the non-anomalous state of the target system 102. In other embodiments, a distribution model can be derived directly from a series of time averaged accuracy scores without using a histogram.

In some embodiments, the anomaly processor 246 may use an anomaly model that evolves over time. For various reasons, the target system 102 may become more or less predictable over time. Similarly, the predictive model 110 may also become more or less accurate over time. For example, the predictive model 110 may perform on-line learning, and produce more accurate predictions as the predictive model 110 is exposed to more input data 104. Due to such changes, the accuracy scores 114 may gradually drift to produce high or lower scores even though the target system 102 is in a non-anomalous state. To account for such natural changes in the accuracy score, the anomaly model 120 may be refreshed continuously, periodically, or modified based on accuracy scores that were determined not to be associated with an anomalous state of the target system 102.

After the anomaly model 120 is generated, the anomaly processor 246 may determine the likelihood that the target system 102 is in an anomalous state by determining whether one or more recently received accuracy scores fluctuate within a range or the accuracy scores are distributed in a manner that was anticipated by the anomaly model 120. The likelihood of the anomalous state is represented by the anomaly parameter 124. Because individual accuracy scores for each prediction may vary abruptly, the anomaly processor 246 may use filtered versions of the accuracy scores to generate the anomaly parameter 124. For example, the anomaly model 120 may compute running average of the accuracy scores to determine the anomaly parameter 124.

In one or more embodiments, the time span associated with the running average or the number of accuracy scores for computing the running average may be dynamically adjusted based on the predictability of the input data 104. If the input data 104 is less predictable, the running average may be set longer to detect an anomalous change. On the other hand, the running average can be shortened if the target system has become more predictable. If the parameter being predicted becomes highly predictable, then a shorter running average can be used to detect an anomalous change in the target system.

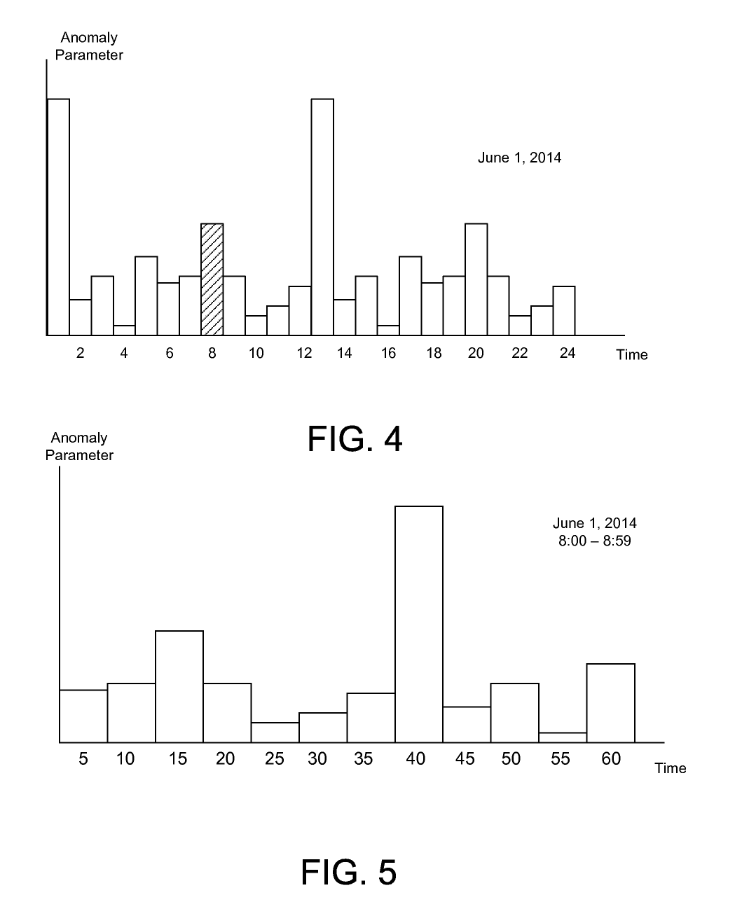

The statistics module 250 receives and stores the anomaly parameter 124 for aggregating as requested by the application 256. A large number of anomaly parameter values without statistical processing may not be decipherable or meaningful to a human user. The statistics module 250 aggregates the anomaly parameter values over certain time periods of time to generate aggregated values that are easier for a user to decipher and understand. For example, anomaly parameters are generated every short period of time (e.g., seconds) into an aggregated parameter covering a longer period of time (e.g., minutes, hours, or days), as described below in detail with reference to FIGS. 4 and 5.

Various functions may be used to aggregate anomaly parameters. The aggregated anomaly parameter for a longer time period (e.g., a day) may show the highest anomaly parameter aggregated over a shorter time period (e.g., an hour). Alternatively, the aggregated anomaly parameters over a longer time period may be the sum of a number of highest anomaly parameters over a shorter time period and exceeding a certain threshold value. In other embodiments, the aggregated anomaly parameter over a longer time period may be the average of anomaly parameters over a shorter time period.

The UI generator 252 receives the aggregated anomaly parameter values from the statistics module 250 and generates graphical user elements such as charts or listings for presentation to the user. Example charts are described below in detail with reference to FIGS. 4 and 5. Based on instructions from the application 256, the UI generator 252 may adjust the granularity of time periods in the charts or listings.

The application 256 is a software component that provides various services to users, including sending graphical user interface screens displaying raw anomaly parameter, aggregated anomaly parameter, and/or alerts associated with anomaly parameters to the users. The application 256 may also perform other functions such as deploying and managing instances of programs onto a cloud computing cluster.

The application 256 also receives user input from a user interface device (e.g., keyboard, mouse or touch screen) connected to the anomaly detector 200 or from another device via the network interface 230. Such user input may instruct the application 256 to generate anomaly parameters with different time aggregations or show anomaly parameters based on different parameters.

### Example Process of Determining Anomalous State

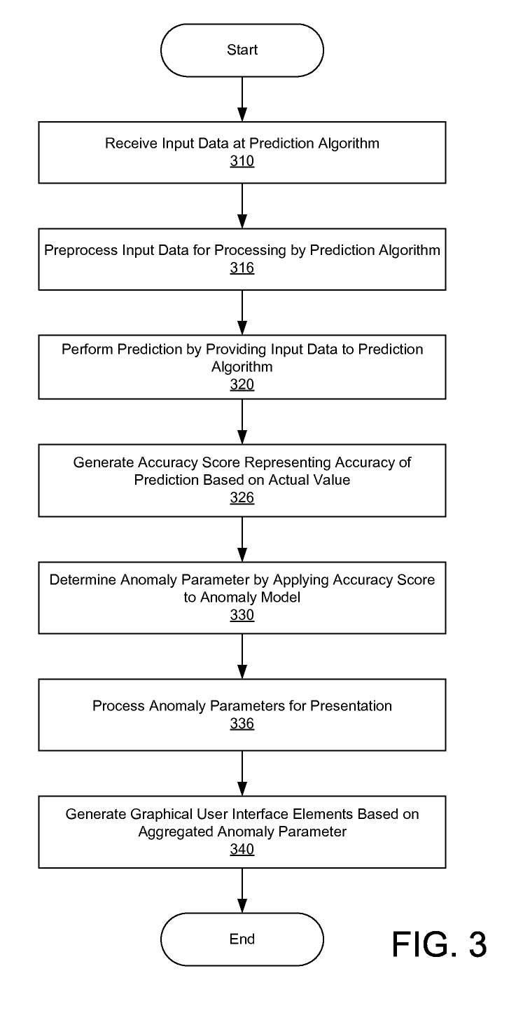

FIG. 3 is a flowchart illustrating a process of determining an anomalous state in a target system, according to one embodiment. First, the predictive algorithm module 242 receives 310 the input data 104 from the target system 102 via the data interface 224. The input data 104 may be collected from sensors deployed in the target system 102, database in the target system 102 or other sources of information.

Then the input data is preprocessed 316 for processing by the predictive algorithm module 242. As described above with reference to FIG. 2, the preprocessing of data makes data to be compatible with the predictive algorithm module 242 and/or enables the predictive algorithm module 242 to perform more accurate predictions. If the data from the target system 102 is already adequate for the predictive algorithm module 242, the preprocessing 316 may be omitted.

The predictive algorithm module 242 may be trained using training data or configured with parameters to perform predictions on the input data. Based on the training or configuration of the predictive algorithm module 242, the predictive algorithm module 242 is provided with the preprocessed input data to perform 320 prediction.

The prediction made by the predictive algorithm module 242 is then compared with a corresponding actual value 108 to generate 326 the accuracy score 114. The accuracy score 114 may then be provided to the anomaly processor 246 to determine 330 the anomaly parameter. The accuracy score 114 may be averaged or processed otherwise using, for example, prior accuracy scores, before being provided to the anomaly processor 246.

The statistics module 250 then processes 336 the current anomaly parameters with previously generated anomaly parameters for presenting to a user according to a command from the application 256. The processing may include, but is not limited to, aggregating, averaging and filtering the anomaly parameters.

Based on the processed anomaly parameters, graphical user interface (GUI) elements (e.g., charts or listings) are generated 340. The generated GUI elements facilitate users to decipher or understand the current state of the target system. The generated GUI elements can be used for display on a display device connected to the display interface 228 of the anomaly detector 200. Alternatively, the generated GUI elements can be sent to other devices over the network interface 230 for display on these devices.

Various changes can be made to the processes and the sequence as illustrated in FIG. 3. For example, preprocessing 316 of the input data may be omitted if the input data provided by the target system 102 is already in a format and content suitable for processing by the predictive algorithm. Further, instead of generating 340 graphical user interface elements, alerts for the users may be generated and sent to the users when the processed anomaly parameters exceed a threshold.

### Example of Anomaly Detection Using HTM/Cortical Learning Algorithm

An example of generating anomaly parameters using a HTM or cortical learning algorithm and a distribution model as the anomaly model is described herein. The HTM or cortical learning algorithm is described, for example, in U.S. patent application Ser. No. 13/046,464 entitled “Temporal Memory Using Sparse Distributed Representation,” filed on Mar. 11, 2011, which is incorporated by reference herein in its entirety.

An HTM or a cortical learning algorithm uses logical constructs called cells and columns where each column includes a subset of these cells. A column in the HTM or the cortical learning algorithm refers to a collection of cells. A cell stores temporal relationship between its activation states and activation states of other cells connected to the cell. A subset of columns may be selected by a sparse vector that is derived from input data. The selection of certain columns causes one or more cells in the selected columns to become active. The relationships of cells in a column and cells in other columns are established during training After training, a column may become predictively active before a sparse vector with an element for activating the column is received.

In one or more embodiments, the number of columns in a current time step and the number of columns predicted to become active in a previous time step can be used to compute the accuracy score. For example, the accuracy score can be computed by the following equation:

PACT/TACT equation (1)

where PACT represents active columns in a current time step that were previously predicted to become active in a current time step, and TACT represents the number of total active columns. The accuracy score will have a value between 0 and 1 where 0 indicates that none of the columns predicted to be active at the current time step is currently active and 1 indicates that all of the columns predicted to be active at the current time step is currently active. The minimum increment of the accuracy score is 1/TACT.

When a distribution model is used as the anomaly model, the anomaly processor 246 may classify an accuracy score (either raw or filtered) to one of these discrete ranges. Taking an example which includes 2048 columns and each sparse vector indicating 40 of such columns as being active, the minimum increment of the accuracy score is 1/40=0.025. The current accuracy score or the running average of the accuracy scores may be binned to one of 40 discrete ranges of [0−0.025], [0.025−0.05], [0.05−0.075] . . . [0.975−1].

The anomaly parameter can then be computed using cumulative distribution function (CDF) for both end values of the classified range. Taking the example where the accuracy score is between 0.05 and 0.075, the anomaly parameter can be computed simply as the difference between CDF (0.075) and CDF (0.05). That is, the anomaly parameter equals CDF (0.075)−CDF (0.05). Assuming that the anomaly parameter is 0.25, this represents that the likelihood of the target system being in a non-anomalous state is 0.25 (25%) based on the current accuracy score.

Although the above example was described with reference to an HTM algorithm or a cortical learning algorithm, similar methods may be used for various other predictive algorithms to generate the anomaly parameters.

### Example Graphical User Interface

A large number of anomaly parameters may be generated as a result of performing predictions on input data 104. When an extensive number of anomaly parameters are presented to users in their raw form, it would be difficult for the users to understand overall trend or changes of the anomaly parameters over time. To facilitate the users to understand the relative significance of the anomaly parameters and trend, the anomaly parameters may be aggregated and presented to users in a graphical user interface such as a bar chart.

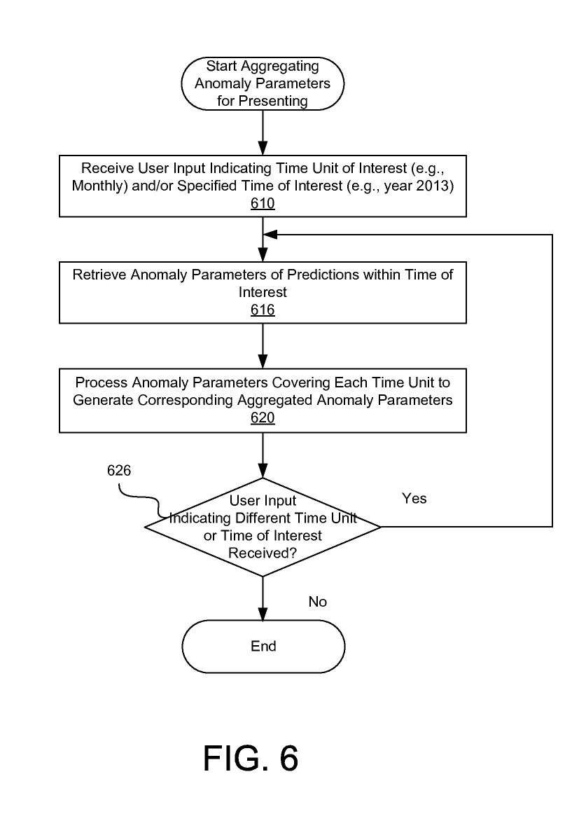

FIG. 4 is an example graphical user interface (i.e., a bar chart) illustrating anomaly parameters aggregated in units of an hour, according to one embodiment. FIG. 5 is an example graphical user interface (i.e., a bar chart) illustrating anomaly parameters aggregated in units of 5 minutes, according to one embodiment. Individual anomaly parameters may be generated every few seconds or minutes. Each of the anomaly parameters may be aggregated over an hour (as shown in FIG. 4), over 5 minutes (as shown in FIG. 5) or over any other time period, and be displayed with other aggregated anomaly parameters spanning over a day (as shown in FIG. 4) over an hour (as shown in FIG. 5) or over any other time period. Each bar in FIGS. 4 and 5 represents an aggregated parameter that is generated by a process as illustrated in detail below with reference to FIG. 6.

In one or more embodiments, an aggregated anomaly parameter over a period as represented by an individual bar can be expanded to reveal a detailed breakdown of multiple aggregated anomaly parameters over a shorter period. For example, when a hashed bar representing the day of Jun. 1, 2014 is selected in FIG. 4, a display screen may transition to display FIG. 5 showing 12 bars where each bar represents an aggregated anomaly parameter over 5 minutes. A user may choose one of the bars representing 5 minute in FIG. 5 to view aggregated anomaly parameters in units of minutes or seconds (not shown). The user may return to a bar chart covering a longer time frame by making a certain motion on a user interface device or selecting certain areas on a screen of a user device displaying the bar charts.

By enabling the user to view aggregated versions of the anomaly parameters over a desired time period, the user can quickly perceive the needed information. The bar charts or other similar graphical user interfaces enables the users, even without detailed technical understanding of the underlying target system 102 or associated models (e.g., predictive model 110 and anomaly model 120), to easily perceive trends and occurrences of anomalous states in the target system 102.

In conjunction with the above embodiment or as an alternative embodiment, a graphical user interface may show a sorted list of a number of highest anomaly parameters over a certain time period. The sorted list may be expanded to show the highest anomaly parameters over a shorter time period or zoomed out to show the highest anomaly parameters over a longer time period.

FIG. 6 is a flowchart illustrating a process of generating aggregated anomaly parameters for presentation, according to one embodiment. First, a user input indicating a time unit of interest (e.g., a month as in FIG. 4) and/or specified time of interest (e.g., year 2013 as in FIG. 4). The time unit of interest may, for example, represent the time period covered by each bar in the bar chart of FIGS. 4 and 5. The specified time of interest may, for example, be the time period collectively covered by the bars in FIGS. 4 and 5.

Based on the indicated time unit of interest and/or specified time of interest. The statistics module 250 retrieves 616 anomaly parameters of the time unit of interest to generate corresponding aggregated anomaly parameters. The aggregated anomaly parameters are then sent to the UI generator 252 or the application 256 for subsequent actions.

It is then determined 626 if another user input indicating a different time unit or time of interest is received from the user. If another user input is received, the process returns to retrieving 616 anomaly parameters within the indicated time of interest and performs subsequent processes. If such user input is not received, the process terminates.

### Multi-Parameter Anomaly Detection

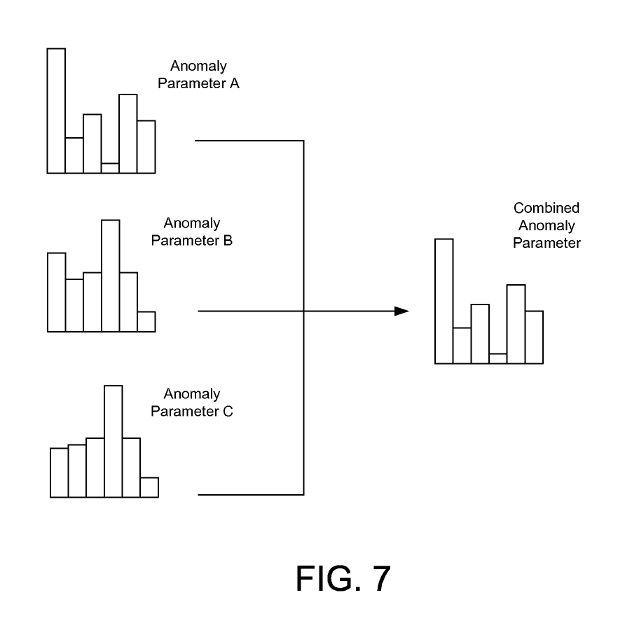

FIG. 7 is a conceptual diagram illustrating generating of combined anomaly parameters of multiple anomaly parameters, according to one embodiment. Based on the input data 104, the predictive algorithm module 242 may generate predictions for different parameters associated with the target system 102. For example, the predictive algorithm module 242 may generate two series of predictions, one series of predictions relating to future temperature of the target system 102 while the other series of predictions relates to future power output of the target system 102. Each of the series of predictions may be used to generate a separate series of anomaly parameters that may be used in conjunction to detect anomaly in the target system 102.

In the example of FIG. 7, the predictive algorithm module 242 generates three series of anomaly parameters (i.e., anomaly parameter A, anomaly parameter B and anomaly parameter C). Each of these anomaly parameters is derived from predictions on different parameters associated with a target system. Instead of relying on one of these anomaly parameters, a combined anomaly parameter derived from three anomaly parameters A, B and C may be used to detect an anomalous state of the target system.

Various functions may be used to combine the anomaly parameters. The function may take the following, for example, as the combined anomaly parameter: (i) the highest value of the three anomaly parameters, (ii) the sum of the all three anomaly parameters and (iii) the average of the three anomaly parameters. Alternatively, a correlation function may be used for these anomaly parameters to detect if there is any deviation from the correlation of different anomaly parameters. For example, if anomaly parameters A and B tend to increase or decrease together under a non-anomalous state, the change in such behavior of anomaly parameters is likely to indicate that the target system is in an anomalous state.

### Alternative Embodiments

Although the above embodiments were described primarily with respect to determining anomalous states in a target system, the same principle may be used to detect other predetermined states of a target system.

In one or more embodiments, multiple predictive models may be used to generate multiple series of predictions. Each predictive model generates a series of predictions. Corresponding predictions (e.g., predictions for the same time step) are then combined to generate a combined prediction in a manner similar to multi-parameter anomaly detection, as described above with reference to FIG. 7. The difference of using multiple predictive models is that different predictions for the same parameter are combined to generate a combined anomaly parameter instead of generating predictions for different parameters.

In one or more embodiments, graphical user elements may be generated at a user device remote from the anomaly detector 200. The user device may be, for example, handheld devices such as smartphones. Instead of generating the graphical user elements at the UI generator 252, the user may receive raw anomaly parameters or partially aggregated anomaly parameters from the anomaly detector 200 and then process these raw or partially aggregated anomaly parameters to generate the graphical user elements.

Upon reading this disclosure, those of skill in the art will appreciate still additional alternative designs for processing nodes. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A method of detecting anomaly in a target system, comprising:
receiving input data associated with the target system;
generating a prediction by executing one or more predictive algorithms based on the received input data;
generating a current accuracy score representing accuracy of the prediction made by the predictive algorithm; and
determining an anomaly score representing likelihood that the target system is in an anomalous state based on the current or one or more recent accuracy scores by referencing an anomaly model representing an anticipated range, or distribution, of accuracy scores made by the predictive model.

2. The method of claim 1, further comprising comparing the prediction with an actual value corresponding to the prediction to generate the current accuracy score.

3. The method of claim 1, further comprising generating the anomaly model by analyzing a plurality of prior accuracy scores generated prior to generating of the current accuracy score, the prior accuracy scores generated by executing the predictive algorithm based on training data or prior input data and comparing the plurality of predictions against a plurality of corresponding actual values.

4. The method of claim 1, wherein the accuracy score takes one of a plurality of discrete values, and the likelihood is determined by computing a difference in cumulative distribution function (CDF) values at an upper end and a lower end of one of the plurality of discrete values.

5. The method of claim 1, wherein determining the likelihood comprises:
computing a running average of the current accuracy score and prior accuracy scores preceding the current accuracy score; and
determining the anomaly score by identifying an output value of the anomaly model corresponding to the running average.

6. The method of claim 5, wherein a number of the prior accuracy scores for computing the running average is dynamically changed based on predictability of the input data.

7. The method of claim 1, further comprising aggregating the accuracy score with one or more prior accuracy scores generated using the input data at time steps prior to a current time step for computing the current accuracy score.

8. The method of claim 7, further comprising receiving a user input indicating a time period represented by the aggregated accuracy score.

9. The method of claim 8, further comprising increasing or decreasing a time period represented by the aggregated accuracy score responsive to receiving another user input.

10. The method of claim 1, wherein the predictive algorithm generates the prediction using a hierarchical temporal memory (HTM) or a cortical learning algorithm.

11. The method of claim 1, further comprising generating a plurality of predictions including the prediction and a corresponding plurality of current accuracy scores based on the same input data, each of the plurality of predictions associated with a different parameter of the target system, the likelihood that the target system is in the anomalous state is determined based on a combined accuracy score that combines the plurality of current accuracy scores.

12. The method of claim 1, further comprising generating a plurality of predictions including the prediction and a corresponding plurality of current accuracy scores based on the same input data and associated with different parameters of the target system, the likelihood that the target system is in the anomalous state is determined based on a change in correlation of at least two of the plurality of current accuracy scores.

13. An anomaly detector for detecting an anomalous state in a target system, comprising:
a processor;
a data interface configured to receive input data associated with the target system;
a predictive algorithm module configure to:
generate a prediction by executing one or more predictive algorithms based on the received input data, and
generate a current accuracy score representing accuracy of the prediction; and
an anomaly processor configured to determine an anomaly score representing likelihood that the target system is in an anomalous state based on the current accuracy score by referencing an anomaly model representing an anticipated range, or distribution of accuracy of predictions made by the predictive model.

14. The anomaly detector of claim 13, wherein the predictive algorithm module is further configured to compare the prediction with an actual value corresponding to the prediction to generate the current accuracy score.

15. The anomaly detector of claim 13, wherein the anomaly processor is configured to generate the anomaly model by analyzing a plurality of prior accuracy scores generated prior to generating the current accuracy score, the prior accuracy scores generated by executing the predictive algorithm based on training data or prior input data provided to the predictive and comparing the plurality of predictions against a plurality of corresponding actual values.

16. The anomaly detector of claim 13, wherein the accuracy score takes one of a plurality of discrete values, and the anomaly processor is configured to determine the likelihood by computing a difference in cumulative distribution function (CDF) values at an upper end and a lower end of one of the plurality of discrete values.

17. The anomaly detector of claim 13, wherein the anomaly processor is further configured to:
compute a running average of the current accuracy score and prior accuracy scores preceding the current accuracy score; and
determine the accuracy score by identifying an output value of the anomaly model corresponding to the running average.

18. The anomaly detector of claim 17, wherein a number of the prior accuracy scores for computing the running average is dynamically changed based on predictability of the input data.

19. The anomaly detector of claim 13, further comprising a statistics module configured to aggregate the accuracy score with one or more prior accuracy scores generated using the input data at time steps prior to a current time step for computing the current accuracy score.

20. A non-transitory computer readable storage medium storing instructions thereon, the instructions when executed by a processor causing the processor to:
receive input data associated with the target system;
generate a prediction by executing one or more predictive algorithms based on the received input data;
generate a current accuracy score representing accuracy of the prediction made by the predictive algorithm; and
determine an anomaly score representing likelihood that the target system is in an anomalous state based on the current accuracy score by referencing an anomaly model representing an anticipated range, or distribution in accuracy of predictions made by the predictive model.
